(19) United States
(12) Patent Application Publication
(10) Pub. No.: US 2009/0274933 A1
(43) Pub. Date: Nov. 5, 2009

(54) PERPENDICULAR MAGNETIC RECORDING MEDIUM

(75) Inventors: Seong-yong YOON, Suwon-si (KR); Hoo-san LEE, Osan-si (KR); Sok-hyun KONG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/277,416

(22) Filed: Nov. 25, 2008

(30) Foreign Application Priority Data
May 1, 2008 (KR) 10-2008-0041055

(51) Int. Cl. G11B 5/667; G11B 5/738; G11B 5/72

(52) U.S. Cl. 428/846

(57) ABSTRACT

Provided is a perpendicular magnetic recording medium. The perpendicular magnetic recording medium includes: a substrate; a soft magnetic layer disposed on the substrate; a recording layer disposed on the soft magnetic layer; and at least one hardness enhancing layer disposed in the soft magnetic layer or interposed between the soft magnetic layer and the recording layer.

### CROSS-REFERENCE TO RELATED PATENT APPLICATION

This application claims priority from Korean Patent Application No. 10-2008-0041055, filed on May 1, 2008 in the Korean Intellectual Property Office, the disclosure of which is incorporated herein in its entirety by reference.

### BACKGROUND OF THE INVENTION

1. Field of the Invention

The present invention relates to a perpendicular magnetic recording medium, and more particularly, to a perpendicular magnetic recording medium that can record and reproduce information more stably.

2. Description of the Related Art

With the rapid increase in the amount of data to be stored, demands for higher density data storage devices for recording and reproducing data have increased. In particular, since magnetic recording devices employing a magnetic recording medium have high storage capacity and high speed access, they have attracted much attention for use as data storage devices for various digital devices as well as computer systems.

Data recording for magnetic recording devices can be roughly classified into longitudinal magnetic recording and perpendicular magnetic recording. In longitudinal magnetic recording, data is recorded using the parallel alignment of the magnetization direction of a magnetic layer with a surface of the magnetic layer. In perpendicular magnetic recording, data is recorded using the perpendicular alignment of a magnetic layer with respect to a surface of the magnetic layer. From the perspective of data recording density, perpendicular magnetic recording is more advantageous than longitudinal magnetic recording.

A perpendicular magnetic recording medium widely used at present generally includes a soft magnetic under layer, a recording layer, and a protective layer. The protective layer includes a diamond-like carbon (DLC) layer and a lubricant layer, and protects a perpendicular magnetic recording medium from direct contact with a magnetic head and prevents corrosion of the recording layer. In such perpendicular magnetic recording medium, when the recording density thereof is increased, a rising height of the magnetic head is required to be low and thicknesses of the DLC layer and the lubricant layer are required to be thin. However, in the perpendicular magnetic recording medium, since a soft magnetic under layer used to increase the recording efficiency is soft, if the rising height of the magnetic head is low and the thickness of the DLC layer is thin, the soft magnetic under layer is pressed when the magnetic head collides with the perpendicular magnetic recording medium. That is, since the perpendicular magnetic recording medium includes the soft magnetic under layer that includes a thick metal layer having a relatively low hardness, increasing the rising height of the magnetic head and decreasing the thickness of the DLC layer reduce the hardness of the DLC layer, which negatively affects the recording stability of the perpendicular magnetic recording medium.

### SUMMARY OF THE INVENTION

The present invention provides a perpendicular magnetic recording medium that includes a thin protective layer and has a highly stable recording structure.

According to an aspect of the present invention, there is provided a perpendicular magnetic recording medium including: a substrate; a soft magnetic layer disposed on the substrate; a recording layer disposed on the soft magnetic layer; and at least one hardness enhancing layer disposed inside the soft magnetic layer or interposed between the soft magnetic layer and the recording layer.

The hardness enhancing layer may be a high hardness layer disposed in a single-layer structure or a double-layer structure.

The hardness enhancing layer may include the high hardness layer and a glue layer which is disposed on or below the high hardness layer.

The glue layer may be formed of a refractory material, for example, may be formed of at least one selected from the group consisting of Ta, Ti, Zr, Hf, Mo, W and Cr.

The hardness enhancing layer may include a seed layer and a high hardness layer disposed on the seed layer.

The high hardness layer may be formed of diamond-like carbon (DLC).

The perpendicular magnetic recording medium may further include an interlayer for controlling the recording layer and disposed below the recording layer.

The hardness enhancing layer may be interposed between the soft magnetic layer and the interlayer.

The soft magnetic layer may include a lower soft magnetic layer and an upper soft magnetic layer which are magnetically separated from each other.

An anisotropy magnetic field of the upper soft magnetic layer may be greater than that of the lower soft magnetic layer.

The upper soft magnetic layer may include a plurality of unit soft magnetic layers; and at least one spacer interposed between the plurality of unit soft magnetic layers and constituting an RKKY coupling structure.

The spacer may be a hardness enhancing layer.

The perpendicular magnetic recording medium may further include an isolation layer interposed between the lower soft magnetic layer and the upper soft magnetic layer and magnetically isolating the lower soft magnetic layer and the upper soft magnetic layer. The isolation layer may be a hardness enhancing layer.

The soft magnetic layer may include: a plurality of unit soft magnetic layers; and a plurality of non-magnetic spacers interposed between the plurality of unit soft magnetic layers.

At least one of the non-magnetic spacers may be a hardness enhancing layer.

### BRIEF DESCRIPTION OF THE DRAWINGS

The above and other aspects of the present invention will become more apparent by describing in detail exemplary embodiments thereof with reference to the attached drawings in which:

FIG. 1 is a schematic cross-sectional view of a perpendicular magnetic recording medium according to an exemplary embodiment of the present invention;

FIG. 2 illustrates a modified example of the perpendicular magnetic recording medium of FIG. 1;

FIG. 3 is a schematic cross-sectional view of a perpendicular magnetic recording medium according to another exemplary embodiment of the present invention;

FIG. 4 is a schematic cross-sectional view of a perpendicular magnetic recording medium according to another exemplary embodiment of the present invention;

FIG. 5 illustrates a modified example of the perpendicular magnetic recording medium of FIG. 4;

FIG. 6 is a schematic cross-sectional view of a perpendicular magnetic recording medium according to another exemplary embodiment of the present invention; and

FIG. 7 is a graph illustrating hardness characteristics of the perpendicular magnetic recording mediums according to the exemplary embodiments of the present invention.

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the exemplary embodiments set forth herein; rather these exemplary embodiments are provided so that this disclosure will be thorough and complete, and will fully convey the concept of the invention to those skilled in the art. In the drawings, the same reference numeral denotes the same element and the thicknesses of elements may be exaggerated for clarity and convenience.

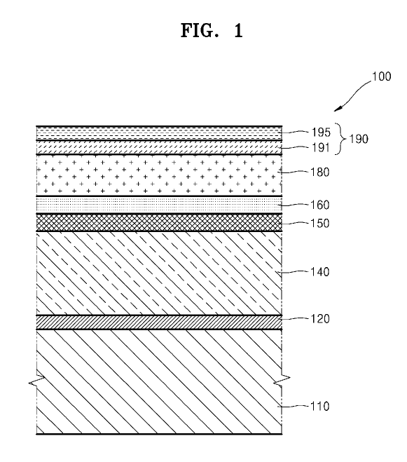

FIG. 1 is a schematic cross-sectional view of a perpendicular magnetic recording medium 100 according to an exemplary embodiment of the present invention.

Referring to FIG. 1, the perpendicular magnetic recording medium 100 includes a substrate 110, a soft magnetic layer 140, a hardness enhancing layer 150, an interlayer 160, a recording layer 180, and a protective layer 190, which are sequentially stacked from the bottom.

The substrate 110 may be formed of any material that can be used to form a substrate of a conventional perpendicular magnetic recording medium, for example, glass, MgO, AlMg, Si, or the like. The substrate 110 may be formed in a disk shape.

The soft magnetic layer 140 forms a magnetic path of a perpendicular magnetic field generated from a magnetic head during a magnetic recording process so as to record information in a recording layer, and may be formed in a single-layer structure or a multi-layer structure. The soft magnetic layer 140 may be formed of any material that can be used to form a soft magnetic layer of a conventional perpendicular magnetic recording medium, for example, a soft magnetic material having a Co-based amorphous structure or including Fe or Ni.

A seed layer 120 may be interposed between the substrate 110 and the soft magnetic layer 140 in order to grow the soft magnetic layer 140. The seed layer 120 may be formed of a well-known material such as Ta, a Ta alloy, or the like. In addition, a buffer layer (not shown) or a magnetic domain control layer (not shown) may be further interposed between the substrate 110 and the soft magnetic layer 140, and since such configuration is widely known in the art, its detailed description will be omitted.

The hardness enhancing layer 150 is formed on the soft magnetic layer 140 in order to enhance hardness of the perpendicular magnetic recording medium 100. Here, the protective layer 190 and the substrate 110 will be referred to as an upper side and a lower side, respectively. The hardness enhancing layer 150 may be formed in a single-layer structure formed of high hardness material with a thickness of about several nm. For example, the hardness enhancing layer 150 may be formed of DLC by using a deposition process, similar to a DLC layer used as a protective layer covering a surface of a conventional perpendicular magnetic recording medium. The hardness enhancing layer 150 prevents the soft magnetic layer 140 from being pressed and moved due to collision with the magnetic head, and furthermore, enhances a surface hardness of the perpendicular magnetic recording medium 100.

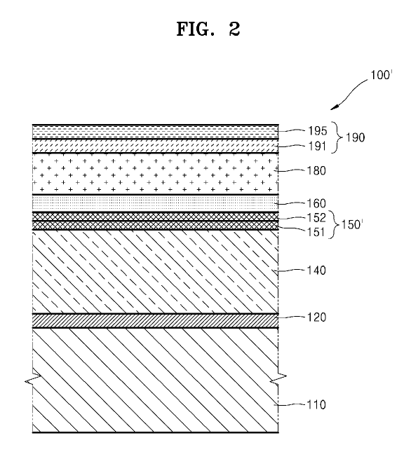

The present exemplary embodiment exemplifies that the hardness enhancing layer 150 is formed in a single-layer structure with a high hardness. However, the present invention is not limited thereto. For example, the hardness enhancing layer 150 may be formed in a double-layer structure including a high hardness layer and an auxiliary layer which is used to stably form the hardness layer. FIG. 2 illustrates a modified example of the hardness enhancing layer 150 of the present exemplary embodiment. Referring to FIG. 2, a hardness enhancing layer 150′ which is a modified example of the hardness enhancing layer 150 is formed in a double-layer structure including a glue layer 151 and a high hardness layer 152. The glue layer 151 may be formed on or below the high hardness layer 152 and is a layer for sufficiently adhering the high hardness layer 152 formed of DLC to the soft magnetic layer 140 or the interlayer 160. The glue layer 151 may be formed of a refractory material, for example, at least one metal selected from the group consisting of Ta, Ti, Zr, Hf, Mo, W and Cr. A seed layer (not shown) may be formed below the high hardness layer 152 as an auxiliary layer for forming a high hardness layer more stably. The seed layer helps DLC to be textured more stably on the soft magnetic layer 140. The glue layer 151 itself may be a seed layer, and the seed layer may be interposed between the glue layer 151 and the high hardness layer 152.

Referring back to FIG. 1, the interlayer 160 for increasing crystalline alignment and magnetic characteristic is formed between the hardness enhancing layer 150 and the recording layer 180. The interlayer 160 may be properly formed according to the material or crystal structure of the recording layer 180. For example, the interlayer 160 may be formed in a single-layer structure or a multi-layer structure including Ru, an Ru alloy, Ru oxide, an alloy including MgO or Ni.

The recording layer 180 is provided for performing magnetic recording and may be formed in a single-layer structure or a multi-layer structure. The recording layer 180 may be formed of any material for forming a recording layer of a conventional perpendicular magnetic recording medium, for example, a magnetic substance including a FePt alloy, FePt alloy oxide, a CoPt alloy, or CoPt alloy oxide.

The protective layer 190 is for protecting the recording layer 180 from the outside and may include a DLC protective layer 191 and a lubricant layer 195. The DLC protective layer 191 deposited with DLC increases a surface hardness of the perpendicular magnetic recording medium 100. The lubricant layer 195 may be formed of a Teraol lubricant or the like, and prevents a magnetic head (not shown) and the DLC protective layer 191 from being worn away due to collision with the magnetic head and sliding.

In the perpendicular magnetic recording medium 100 of the present exemplary embodiment, since the hardness enhancing layer 150 is interposed between the soft magnetic layer 140 and the interlayer 160, even though the DLC protective layer 191 formed on the recording layer 180 is formed to be thin, hardness of the perpendicular magnetic recording medium 100 can be maintained. As such, a distance between the magnetic head and the recording layer 180 can be reduced by forming the DLC protective layer 191 to be thin, and thus the perpendicular magnetic recording medium 100 of the present exemplary embodiment can have a higher recording density.

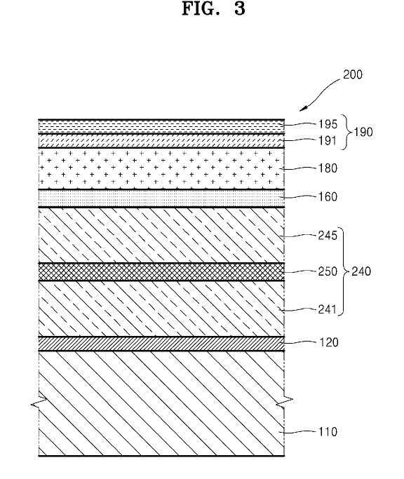

FIG. 3 is a schematic cross-sectional view of a perpendicular magnetic recording medium 200 according to another exemplary embodiment of the present invention.

Referring to FIG. 3, the perpendicular magnetic recording medium 200 includes a substrate 110, a seed layer 120, a soft magnetic layer 240 formed in a multi-layer structure, a hardness enhancing layer 250, an interlayer 160, a recording layer 180, and a protective layer 190, which are sequentially stacked from the bottom.

Since the substrate 110, the interlayer 160, the recording layer 180, and the protective layer 190 are the same as described in the previous exemplary embodiment, only differences between the present exemplary embodiment and the previous exemplary embodiment will be mainly described.

The soft magnetic layer 240 is formed in a double-layer structure including a lower soft magnetic layer 241 and an upper soft magnetic layer 245 which are magnetically separated from each other. The hardness enhancing layer 250 is interposed between the lower soft magnetic layer 241 and the upper soft magnetic layer 245.

An anisotropy magnetic field (Hk) of the upper soft magnetic layer 245 is greater than that of the lower soft magnetic layer 241, and the lower soft magnetic layer 241 and the upper soft magnetic layer 245 are magnetically separated from each other. The lower and upper soft magnetic layers 241 and 245 are magnetized to be formed so as to form a magnetization easy axis in a cross-track direction of the perpendicular magnetic recording medium 100. The lower soft magnetic layer 241 efficiently draws a recording field generated from a magnetic head, and may be formed thicker than the upper soft magnetic layer 245 so as to form a magnetic path of the recording field. The lower soft magnetic layer 241 may be formed to have a thickness in the range of about 10 nm through 100 nm, and the upper soft magnetic layer 245 may be formed with a thickness in the range of about 1 nm through 20 nm. The lower soft magnetic layer 241 may be formed of one selected from the group consisting of an NiFe alloy, CoZrNb, CoZrTa, an FeTa alloy, and an FeCo alloy, and the upper soft magnetic layer 245 may be formed of one selected from the group consisting of CoZrNb, CoZrTa, an FeTa alloy, and an FeCo alloy.

In the soft magnetic layer 240 of the present exemplary embodiment, an anisotropy magnetic field (Hk) of the upper soft magnetic layer 245 is greater than that of the lower soft magnetic layer 241, and the lower soft magnetic layer 241 and the upper soft magnetic layer 245 are magnetically separated from each other, so that a recording field generated from a magnetic head can be efficiently drawn by the lower soft magnetic layer 241 during a recording operation, and a stray field can be efficiently controlled by the upper soft magnetic layer 241 during a reproducing operation.

The hardness enhancing layer 250 of the present exemplary embodiment enhances hardness of the perpendicular magnetic recording medium 200 and functions as an isolation layer for suppressing a magnetic interaction between the lower soft magnetic layer 241 and the upper soft magnetic layer 245. The hardness enhancing layer 250 may be formed of a non-magnetic metallic material or a non-magnetic nonmetallic material with a high hardness and a thickness of more than several nm. For example, the hardness enhancing layer 250 may be formed in a double-layer structure including a DLC single high hardness layer or a glue layer/high hardness layer.

As such, the hardness enhancing layer 250 is interposed between the lower soft magnetic layer 241 and the upper soft magnetic layer 245, so that a magnetic characteristic of the soft magnetic layer 240 can be increased, and also, hardness of the soft magnetic layer 240 can be greatly increased. As the hardness of the soft magnetic layer 240 increases, a surface hardness of the perpendicular magnetic recording medium 200 is enhanced, and thus the thickness of the protective layer 190 can be reduced. Thus, the perpendicular magnetic recording medium 200 has high recording density.

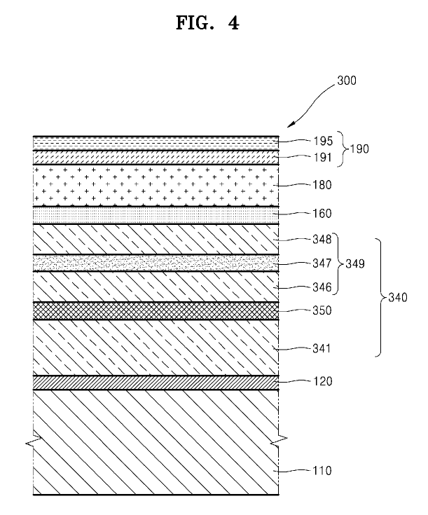

FIG. 4 is a schematic cross-sectional view of a perpendicular magnetic recording medium 300 according to another exemplary embodiment of the present invention.

Referring to FIG. 4, the perpendicular magnetic recording medium 300 of the present exemplary embodiment includes a substrate 110, a seed layer 120, a soft magnetic layer 340 formed in a multi-layer structure, a hardness enhancing layer 350, an interlayer 160, a recording layer 180, and a protective layer 190, which are sequentially stacked from the below.

Since the substrate 110, the interlayer 160, the recording layer 180, and the protective layer 190 have been described with respect to FIG. 1, only the differences between the present exemplary embodiment and the exemplary embodiment described with respect to FIG. 1 will be mainly described.

The soft magnetic layer 340 of the present exemplary embodiment is formed in a double-layer structure including a lower soft magnetic layer 341 which is magnetically isolated and an upper soft magnetic layer 349. The hardness enhancing layer 350 is interposed between the lower soft magnetic layer 341 and the upper soft magnetic layer 349. An anisotropy magnetic field (Hk) of the upper soft magnetic layer 349 is greater than that of the lower soft magnetic layer 341, and the lower soft magnetic layer 341 and the upper soft magnetic layer 349 are magnetically separated from each other.

In order to make the anisotropy magnetic field (Hk) of the upper soft magnetic layer 349 greater than that of the lower soft magnetic layer 241, the upper soft magnetic layer 349 of the present exemplary embodiment may have a Ruderman-Kittel-Kasuya-Yosida (RKKY) coupling structure. That is, the upper soft magnetic layer 349 may have a sandwich structure in which a first unit soft magnetic layer 346, a spacer 347, and a second unit soft magnetic layer 348 are sequentially stacked. Here, the RKKY coupling structure means a structure wherein an upper magnetic substance and a lower magnetic substance are antiferromagnetically coupled by interposing a non-magnetic metal layer therebetween. In order to prevent formation of a domain wall generating noise, an anisotropy magnetic field of the upper soft magnetic layer 349 needs to be strong. The strong anisotropy magnetic field may be obtained by controlling thicknesses of the first and second unit soft magnetic layers 346 and 348. For example, the first and second unit soft magnetic layers 346 and 348 may be formed to have a thickness of about 5 nm or less than 5 nm. As such, by forming the upper soft magnetic layer 349 in the RKKY coupling structure, the lower and upper soft magnetic layers 341 and 349 may be formed of the same material, in addition, the anisotropy magnetic field (Hk) of the upper soft magnetic layer 349 may be greater than that of the lower soft magnetic layer 341. The present exemplary embodiment exemplifies that the first and second unit soft magnetic layers 346 and 348 are coupled to each other in a sandwich structure. However, the present invention is not limited thereto. For example, the upper soft magnetic layer 349 may be formed of more than three unit soft magnetic layers having the RKKY coupling structure.

The spacer 347 may be formed of a non-magnetic material with a thickness of less than 2 nm, for example, 0.8 nm, in order to antiferromagnetically couple the first and second unit soft magnetic layers 346 and 348. The spacer 347 may be formed of a non-magnetic material such as Ru. Furthermore, by forming the spacer 347 of a non-magnetic material with a high hardness such as DLC, the spacer 347 may function as a hardness enhancing layer.

The hardness enhancing layer 350 of the present exemplary embodiment may be a single high hardness layer formed of a non-magnetic metallic material with a high hardness such as DLC or a non-magnetic nonmetallic material with a thickness of more than several nm. The hardness enhancing layer 350 enhances hardness of the perpendicular magnetic recording medium 300 and functions as an isolation layer for suppressing a magnetic interaction between the lower soft magnetic layer 341 and the upper soft magnetic layer 349.

The present exemplary embodiment exemplifies that the hardness enhancing layer 350 is a single high hardness layer. However, the present invention is not limited thereto. The hardness enhancing layer 350 may be formed in a double-layer structure including a high hardness layer and an auxiliary layer which is used stably form the high hardness layer.

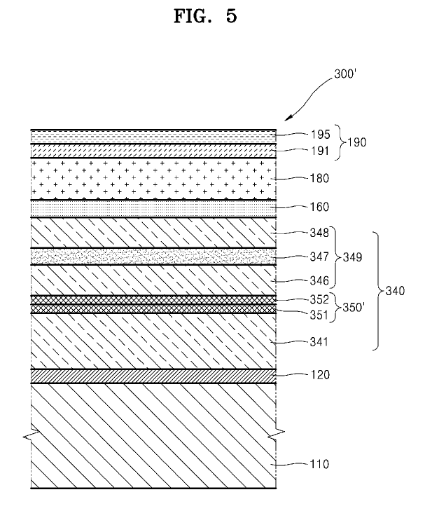

FIG. 5 illustrates a modified example of the hardness enhancing layer 350 of FIG. 4.

Referring to FIG. 5, a hardness enhancing layer 350′ is formed in a double-layer structure including a glue layer 351 and a high hardness layer 352. The glue layer 351 is formed below or on the high hardness layer 352 for sufficiently adhering the high hardness layer 352 formed of DLC to the soft magnetic layer 340 or an interlayer 360. Since the double-layer structure including the glue layer 151 and the high hardness layer 352 is substantially the same as the exemplary embodiment of FIG. 2 described above, its detailed description will be omitted.

Referring back to FIG. 4, the hardness enhancing layer 350 is used as an isolation layer for improving a magnetic characteristic of the soft magnetic layer 340, so that hardness of the perpendicular magnetic recording medium 300 is increased. Furthermore, the spacer 347, which is a part constituting the RKKY coupling structure of the upper soft magnetic layer 349, is formed of a high hardness material, so that hardness of the perpendicular magnetic recording medium 300 can be increased more.

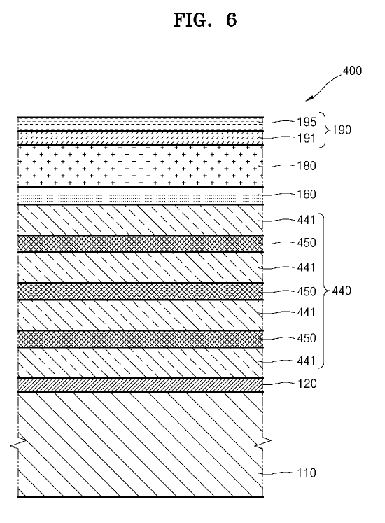

FIG. 6 is a schematic cross-sectional view of a perpendicular magnetic recording medium 400 according to another exemplary embodiment of the present invention.

Referring to FIG. 6, the perpendicular magnetic recording medium 400 of the present exemplary embodiment includes a substrate 110, a seed layer 120, a soft magnetic layer 440 formed in a multi-layer structure, non-magnetic spacers 450, an interlayer 160, a recording layer 180, and a protective layer 190, which are sequentially stacked from the bottom.

Since the substrate 110, the interlayer 160, the recording layer 180, and the protective layer 190 are the same as described with respect to FIG. 1, only the differences between the present exemplary embodiment and the exemplary embodiment described with respect to FIG. 1 will be mainly described.

The soft magnetic layer 440 of the present exemplary embodiment is formed in a multi-layer structure including a plurality of unit soft magnetic layers 441. The non-magnetic spacers 450 are interposed between the unit soft magnetic layers 441. At least one of the non-magnetic spacers 450 is formed of a high hardness material, such as DLC, to function as a hardness enhancing layer. All the non-magnetic spacers 450 may be formed of a high hardness material. However, the present invention is not limited thereto. For example, the non-magnetic spacers 450 may be partially formed of Ta, or the like.

Since the unit soft magnetic layers 441 with the non-magnetic spacers 450 interposed therebetween are tightly and magnetically coupled to each other, formation of a domain wall can be controlled in a state where a magnetic permeability and an anisotropy magnetic field are maintained to a certain degree, and thus a noise removal effect can be increased.

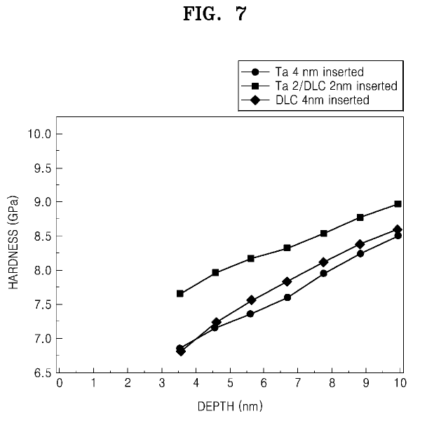

FIG. 7 is a graph illustrating hardness characteristics of the perpendicular magnetic recording mediums according to the exemplary embodiments of the present invention.

In order to examine a hardness characteristic of the perpendicular magnetic recording medium of the present invention, in the perpendicular magnetic recording medium having a soft magnetic structure including lower and upper soft magnetic layers, hardness around a surface of the perpendicular magnetic recording medium is measured by differing only a material and structure of an isolation layer interposed between the lower soft magnetic layer and the upper soft magnetic layer.

First, in order to examine the hardness characteristic of the perpendicular magnetic recording medium according to exemplary embodiments of the present invention, a hardness enhancing layer formed in a single-layer structure and a hardness enhancing layer formed in a double-layer structure are used as isolation layers. When the hardness enhancing layer formed in a single-layer structure is used as an isolation layer, the perpendicular magnetic recording medium has the structure illustrated in FIG. 5. The hardness enhancing layer is formed in a double-layer structure including Ta and DLC with thicknesses of 2 nm, respectively. On the other hand, a comparative example illustrates a case where a perpendicular magnetic recording medium having a similar structure to the perpendicular magnetic recording medium illustrated in FIG. 4 and using an isolation layer, formed of Ta and with a thickness of 4 nm, as an isolation layer instead of using a hardness enhancing layer. DLC has a high hardness of ta-c (<80 GPa), a-c (<60 GPa) in a crystal axis direction, on the other hand, Ta has a relatively low hardness of about 11.6 GPa.

According to the above measurement, as illustrated in FIG. 7, the perpendicular magnetic recording medium using the hardness enhancing layer formed in a single-layer structure including DLC or the double-layer structure including Ta/DLC as an isolation layer has a higher hardness than the perpendicular magnetic recording medium which is a comparative example, and uses the Ta isolation layer. In particular, the perpendicular magnetic recording medium formed in a double-layer structure including Ta/DLC has a relatively and extremely high hardness around a surface of the perpendicular magnetic recording medium.

The exemplary embodiments of the present invention is characteristic in that a hardness enhancing layer formed of a high hardness material is interposed between a recording layer and a soft magnetic layer or in a soft magnetic layer, so that hardness of a perpendicular magnetic recording medium can be sufficiently ensured and a protective layer of the perpendicular magnetic recording medium thin can be formed thinner. In the aforementioned exemplary embodiments, the hardness enhancing layer is formed of a DLC material. However, the present invention is not limited thereto. In the present invention, a hardness enhancing layer can be formed of a material having a relatively high hardness instead of a material that is conventionally used as a material interposed between a recording layer and a soft magnetic layer.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A perpendicular magnetic recording medium comprising:
a substrate;
a soft magnetic layer disposed on the substrate;
a recording layer disposed on the soft magnetic layer; and
at least one hardness enhancing layer disposed inside the soft magnetic layer or interposed between the soft magnetic layer and the recording layer.

2. The perpendicular magnetic recording medium of claim 1, wherein the hardness enhancing layer has a single-layer structure or a double-layer structure.

3. The perpendicular magnetic recording medium of claim 1, wherein the hardness enhancing layer comprises a high hardness layer and a glue layer disposed on or below the high hardness layer.

4. The perpendicular magnetic recording medium of claim 3, wherein the glue layer is formed of a refractory material.

5. The perpendicular magnetic recording medium of claim 4, wherein the refractory material comprises at least one selected from the group consisting of Ta, Ti, Zr, Hf, Mo, W and Cr.

6. The perpendicular magnetic recording medium of claim 1, wherein the hardness enhancing layer comprises a seed layer and a high hardness layer which is disposed on the seed layer.

7. The perpendicular magnetic recording medium of claim 2, wherein the high hardness layer is formed of diamond-like carbon (DLC).

8. The perpendicular magnetic recording medium of claim 1, further comprising a protective layer disposed on the recording layer.

9. The perpendicular magnetic recording medium of claim 1, further comprising an interlayer for controlling the recording layer and disposed below the recording layer.

10. The perpendicular magnetic recording medium of claim 9, wherein the hardness enhancing layer is interposed between the soft magnetic layer and the interlayer.

11. The perpendicular magnetic recording medium of claim 1, wherein the soft magnetic layer comprises a lower soft magnetic layer and an upper soft magnetic layer which are magnetically separated from each other.

12. The perpendicular magnetic recording medium of claim 11, wherein an anisotropy magnetic field of the upper soft magnetic layer is greater than an anisotropy of the lower soft magnetic layer.

13. The perpendicular magnetic recording medium of claim 12, wherein the upper soft magnetic layer comprises:
a plurality of unit soft magnetic layers; and
at least one spacer interposed between the plurality of unit soft magnetic layers and constituting a Ruderman-Kittel-Kasuya-Yosida coupling structure.

14. The perpendicular magnetic recording medium of claim 13, wherein the spacer is a hardness enhancing layer.

15. The perpendicular magnetic recording medium of claim 11, further comprising an isolation layer interposed between the lower soft magnetic layer and the upper soft magnetic layer, the isolation layer magnetically isolating the lower soft magnetic layer and the upper soft magnetic layer.

16. The perpendicular magnetic recording medium of claim 15, wherein the isolation layer is a hardness enhancing layer.

17. The perpendicular magnetic recording medium of claim 11, wherein the soft magnetic layer comprises:
a plurality of unit soft magnetic layers; and
a plurality of non-magnetic spacers interposed between the plurality of unit soft magnetic layers.

18. The perpendicular magnetic recording medium of claim 17, wherein at least one of the plurality of non-magnetic spacers is a hardness enhancing layer.
